(19) United States
(12) Patent Application Publication
(10) Pub. No.: US 2010/0177354 A1
(43) Pub. Date: Jul. 15, 2010

(54) PRINTING APPARATUS, METHOD OF CREATING LOOKUP TABLE, LOOKUP TABLE, PRINTING METHOD, AND PRINTED PRODUCT

(75) Inventor: Seishin Yoshida, Azumino-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Tokyo (JP)

(21) Appl. No.: 12/685,622

(22) Filed: Jan. 11, 2010

(30) Foreign Application Priority Data
Jan. 13, 2009 (JP) 2009-004893

(51) Int. Cl. H04N 1/40

(52) U.S. Cl. 358/3.01

(57) ABSTRACT

A printing apparatus for performing printing using a special gloss material and a coloring material, includes: an input unit that inputs image data; and a printing unit that controls an arrangement of the special gloss material and the coloring material on a printing medium on the basis of the input data and prints the image data, wherein the printing unit relatively reduces an amount of the special gloss material to be used in a shadow region that is a printing region where an index value relating to color intensity expressed by the coloring material is equal to or lower than a predetermined darkness value.

### BACKGROUND

1. Technical Field

The present invention relates to a printing technique for performing printing using a special gloss material and a coloring material.

2. Related Art

In general, there is known a method of forming an undercoat layer on a printing medium and then printing on the undercoat layer (for example, refer to JP-T-2002-530229). Such a method can be used for various printing methods. For example, it can be used for a case where a variety of metallic colors are to be reproduced. In order to reproduce metallic colors, for example, a metallic ink layer is formed on a printing medium and a color ink layer is overlapped thereon to be printed.

Another example of the above-described related art is disclosed in JP-A-2005-52984.

However, since metallic inks are relatively expensive, effectively reducing amounts of metallic inks used has been required. In addition, particularly, in an ink jet printer, when an ink duty of color ink is relatively high, the duty limitation becomes unnecessarily severe for the amount of metallic ink overlapped. As a result, there is a problem in that the color reproduction range narrows. This problem is not limited to metallic inks containing metal pigments for expressing a metallic gloss feel, and is, for example, common to cases where various special gloss inks for expressing textures in addition to colors are used such as inks containing pigments for expressing a gloss feel similar to pearly gloss. In addition, this problem is not limited to special gloss inks of an ink jet printer and is common to various types of printing apparatus for performing printing using special gloss materials and coloring material is used.

### SUMMARY

An advantage of some aspects of the invention is that it effectively saves a special gloss material while considering printing quality.

The invention has been made to solve at least a part of the problems and can be realized as the following embodiments or Applications.

### First Application

There is provided a printing apparatus for performing printing using a special gloss material and a coloring material, including: an input unit that inputs image data; and a printing unit that controls the arrangement of the special gloss material and the coloring material on a printing medium on the basis of the input image data and prints the image data, wherein the printing unit relatively reduces an amount of the special gloss material to be used in a shadow region that is a printing region where an index value relating to color intensity expressed by the coloring material is equal to or lower than a predetermined darkness value.

In the printing apparatus with such a configuration, the amount of the special gloss material used is relatively reduced in a shadow region. In the shadow region, since an amount of the coloring material used is increased, the special gloss expression effect due to the special gloss material is relatively small. Therefore, it is possible to effectively save the special gloss material. In addition, in a case where the printing apparatus is an ink jet printer, the amount of the coloring material used is unnecessarily restricted by the amount of the special gloss material used due to a problem of bleeding of the coloring material or the like, and as a result, the color reproduction range narrows in the shadow region where the amount of the coloring material used is high. However, this problem can be suppressed.

### Second Application

In the printing apparatus according to First Application, the printing unit reduces an amount of the special gloss material to be used as the index value is darker in the shadow region.

In the printing apparatus with such a configuration, since the amount of the special gloss material to be used is reduced according to index values, a gradation change in intensity in the shadow region becomes smooth, and the degradation in printing quality can be suppressed.

### Third Application

In the printing apparatus according to First or Second Application, the predetermined value is a dark value to be equal to or lower than the index value at the intersection between a line representing the relationship between a color gradation of a printing region and the index value in a case where printing is performed using only the coloring material and a line representing the relationship between a color gradation of a printing region and the index value in a case where printing is performed using the coloring material and the special gloss material.

In the printing apparatus with such a configuration, the amount of the special gloss material to be used is reduced in a region where the predetermined value is dark to be equal to or lower than the index value at the intersection between a line representing a relationship between a color gradation of a printing region and the index value in a case where printing is performed using only the coloring material and a line representing relationship between a color gradation of a printing region and the index value in a case where printing is performed using the coloring material and the special gloss material. Therefore, there is no situation in which the index value that decreases with an increase in color gradation value at a point where the amount of the special gloss material used is reduced locally increases. Accordingly, a gradation change in intensity becomes smooth before and after the color gradation for reducing the amount of the special gloss material used, so that the degradation in printing quality can be suppressed.

### Fourth Application

In the printing apparatus according to First to Third Applications, the index value is brightness.

In the printing apparatus with such a configuration, the index value may be brightness. In addition, as well as the brightness, luminance, ink duty, and the like may be employed.

### Fifth Application

In the printing apparatus according to Fourth Application, the brightness is a value measured at a light-receiving angle of 0 degrees and an illumination angle of −45 degrees.

In the printing apparatus with such a configuration, a measurement condition of brightness may be a light-receiving angle of 0 degrees and an illumination angle of −45 degrees. In this case, the range for relatively reducing the special gloss material can be determined at a precision close to the discrimination power of human eyes.

In addition, the invention can be implemented as a method of creating a lookup table of Sixth to Tenth Applications, a lookup table of Eleventh Application, a printing method of Twelfth Application, a printed product of Thirteenth Application, computer programs, a recording medium recording the programs, and the like, as well as the configuration of the printing apparatus.

### Sixth Application

There is provided a method of creating a lookup table which describes a correspondence relationship between an input value to a printing apparatus and output values of a special gloss material and a coloring material of the printing apparatus, the method including: preparing an existing lookup table that describes a correspondence relationship between the input value and the output value of the coloring material; and adding the output value of the special gloss material to the output value of the coloring material for each lattice point of the existing lookup table and creating a new lookup table, wherein the output value of the special gloss material which is added is relatively reduced at a lattice point where an index value relating to color intensity expressed by the output value of the coloring material is equal to or lower than a predetermined darkness value.

### Seventh Application

In the method according to Sixth Application, the output value of the special gloss material which is added is reduced as the index value is darker at a lattice point where the index value is equal to or lower than a predetermined darkness value.

### Eighth Application

In the method according to Sixth or Seventh Application, the method further includes: a first color measurement process of performing color measurement on the index value for each predetermined color gradation in a printing region printed by using only the coloring material; a second color measurement process of performing color measurement on the index value for each predetermined color gradation in a printing region printed by using the coloring material and the special gloss material; and a process for obtaining an intersection index value that is the index value at the intersection between a line representing the relationship between the color gradation and the index value obtained in the first color measurement and a line representing the relationship between the color gradation and the index value obtained in the second color measurement, wherein the predetermined value is a dark value to be equal to or lower than the intersection index value.

### Ninth Application

In the method according to Sixth to Eighth Applications, the index value is brightness.

### Tenth Application

In the method according to Ninth Application, the brightness is a value measured at a light-receiving angle of 0 degrees and an illumination angle of −45 degrees.

### Eleventh Application

There is provided a lookup table that describes a correspondence relationship between an input value to a printing apparatus and output values of a special gloss material and a coloring material of the printing apparatus, wherein the output value of the special gloss material is relatively reduced at a lattice point where an index value relating to color intensity expressed by the output value of the coloring material is equal to or lower than a predetermined darkness value.

### Twelfth Application

There is provided a printing method of performing printing using a special gloss material and a coloring material, the printing method including: relatively reducing an amount of the special gloss material to be used in a printing region where an index value relating to color intensity expressed by the coloring material is equal to or lower than a predetermined darkness value.

### Thirteenth Application

There is provided a printed product printed using a special gloss material and a coloring material, wherein an amount of the special gloss material used is relatively small in a printing region where an index value relating to color intensity expressed by the coloring material is equal to or lower than a predetermined darkness value from among printing regions printed by overlapping the special gloss material and the coloring material with each other.

### BRIEF DESCRIPTION OF THE DRAWINGS

The invention will be described with reference to the accompanying drawings, wherein like numbers reference like elements.

FIG. 1 is a diagram schematically illustrating a configuration of a printer according to an embodiment of the invention.

FIG. 2 is a flowchart of a printing process of the printer.

FIG. 3 is a flowchart of a method of creating a LUT.

FIG. 4 is an RGB color space showing predetermined colors for creating a color patch.

FIG. 5 is an explanatory view showing a relationship between L* and a metallic ink duty in a color line CL1.

FIG. 6 is an explanatory view showing a relationship between L* and a metallic ink duty in a color line CL4.

FIG. 7 is an explanatory view showing a relationship between a color ink duty and a metallic ink duty according to Modified Example.

### DESCRIPTION OF EXEMPLARY EMBODIMENTS

### A. Overview of Printing Apparatus

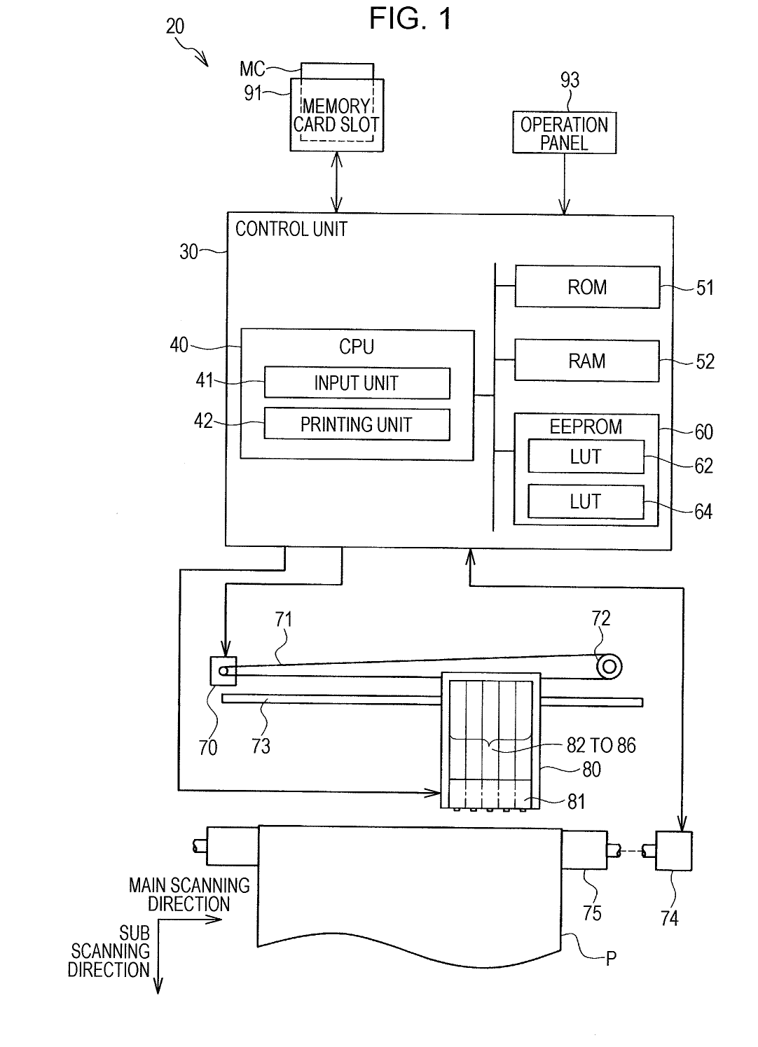

FIG. 1 is a diagram schematically illustrating a configuration of a printer 20 according to an embodiment of the invention. As illustrated in FIG. 1, the printer 20 includes a mechanism for transporting a printing medium P by a paper feed motor 74, a mechanism for reciprocating a carriage 80 in an axial direction of a platen 75 by a carriage motor 70, a mechanism for ejecting inks and forming dots by driving a print head 81 mounted in the carriage 80, and a control unit 30 for signal transmission/reception between the paper feed motor 74, the carriage motor 70, the print head 81, and an operation panel 93.

The mechanism for reciprocating the carriage 80 in the axial direction of the platen 75 includes a sliding shaft 73 which is provided in parallel with the axis of the platen 75 for holding the carriage 80 to slide, and a pulley 72 with which an endless drive belt 71 runs between the carriage motor 70 and the pulley 72, and the like.

Ink cartridges 82 to 85 for color inks which respectively contain cyan ink C, magenta ink M, yellow ink Y, and black ink K as color inks are mounted in the carriage 80. In addition, an ink cartridge 86 for metallic ink which contains metallic ink S is mounted in the carriage 80. A print head 81 provided at a lower portion of the carriage 80 is provided with nozzle rows corresponding to the color inks and the metallic ink S described above. When the ink cartridges 82 to 86 are loaded in the carriage 80 from above, ink can be supplied to the ink head 81 from each cartridge.

In this embodiment, “color ink” includes the black ink. In addition, in this embodiment, color ink uses pigment ink.

Metallic ink is an ink for allowing a printed product to express a metallic feel, and for example, an oil-based ink composition containing a metal pigment, an organic solvent, and a resin may be used as the metallic ink. In order to effectively visualize metallic texture, it is preferable that the metal pigment described above have plate-like particles, and assuming that a major diameter of the plate-like particle in a plane is X, a minor diameter thereof is Y, and a thickness thereof is Z, it is preferable that a 50% average particle diameter R50 be in the range of 0.5 to 3 μm as the circle-equivalent diameter obtained from an area of an X-Y plane of the plate-like particle and a condition of R50/Z>5 be satisfied. The metal pigment may be made of aluminum or an aluminum alloy and may also be made by fracturing a metal deposition layer. A concentration of the metal pigment contained in the metallic ink is, for example, in a range of 0.1 to 10.0 wt. %. Of course, the metallic ink is not limited to such a composition, and may suitably employ other compositions as long as the composition expresses a metallic feel.

In this embodiment, the composition of the metallic ink S includes 1.5 wt. % of aluminum pigment, 20 wt. % of glycerin, 40 wt. % of triethylene glycol monobutyl ether, and 0.1 wt. % of BYK-UV3500 (manufactured by BYK-Chemie Japan K.K.)

The control unit 30 configured by connecting the CPU 40, the ROM 51, the RAM 52, and the EEPROM 60 via a bus. The control unit 30 also functions as an input unit 41 and a printing unit 42 by deploying and executing programs stored in the ROM 51 or the EEPROM 60 on the RAM 52. The details of those function units are described later.

The control unit 30 is connected to a memory card slot 91 and reads and input image data ORG from a memory card MC inserted into the memory card slot 91. In this embodiment, the image data ORG input from the memory card MC is data made from three color components for red (R), green (G), and blue (B).

In addition, the control unit 30 may receive an instruction from a user through the operation panel 93 or the like and designate a region (hereinafter, referred to as a “metallic region”) composed of metallic color besides regions composed of R, G, and B color components, with respect to an arbitrary region in the input image data ORG. The metallic region and the color region may be designated to overlap with each other (the overlapping region is referred to as a “metallic color region”, a region composed of only R, G, and B color components is referred to as a “color-only region”, and a region composed of only metallic color is referred to as a “metallic-only region”). That is, an area may be designated to allow printing to mix dots formed of color ink and dots formed of metallic ink together in the same region.

The EEPROM 60 stores a lookup table (LUT) 62 in which the relationship between an input value in an RGB form and an output value in a CMYKS form is described, and a LUT 64 in which the relationship between an input value in an RGB form and an output value in a CMYK form is described.

The printer 20 having the above-mentioned hardware configuration reciprocates the print head 81 in a main scanning direction with respect to the printing medium P by driving the carriage motor 70 and moves the printing medium P in a sub scanning direction by driving the paper feed motor 74. The control unit 30 drives the nozzles at the appropriate timing on the basis of the print data according to the reciprocation movement (main scanning) of the carriage 80 and the transportation movement (sub scanning) of the printing medium, such as a paper, to form ink dots of suitable colors at suitable positions on the printing medium P. Accordingly, the printer 20 can print a color image input from the memory card MC on the printing medium P.

### B. Printing Process

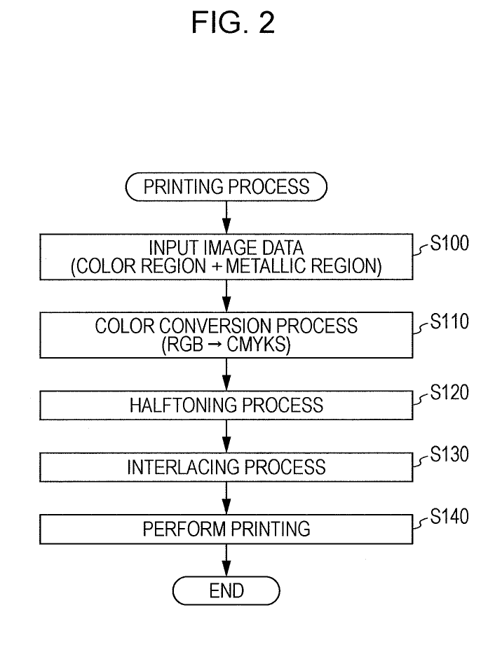

A printing process of the printer 20 will be described. FIG. 2 is a flowchart of a printing process according to this embodiment. The printing process is a process for printing metallic colors and is started when the user operates a print instruction of a predetermined image stored in the memory card MC using the operation panel 93. In this embodiment, the user operates the print instruction and designates a metallic region for an image to be printed. When the printing process is started, the CPU 40, first, as a process of the input unit 41, reads the image data ORG in an RGB form to be printed from the memory card MC through the memory card slot 91 and inputs data including color regions and metallic regions (Step S100).

When the image data is input, the CPU 40 converts the image data ORG into image data in a CMYKS form that can be expressed by the printer 20 on the basis of the LUTs 62 and 64 stored in the EEPROM 60 (Step S110). In this embodiment, the CPU 40 performs a color conversion process using the LUT 62 for the metallic regions (metallic color region and metallic-only region) and the LUT 64 for the color-only region. In addition, the LUTs 62 and 64 may be stored on other storage media, for example, a hard disk drive, or may be downloaded from a computer or the like connected to the printer 20.

When the color conversion process is performed, the CPU 40 performs a halftoning process of converting the image data to be subjected to the color conversion process into ON/OFF data of a dot of each color (Step S120). Here, a well-known systematic dither method is used. When the halftoning process is performed, the CPU 40 performs an interlacing process of re-arranging the data into dot pattern data to be printed in units of one main scanning according to a nozzle arrangement and a paper feed amount of the printer 20 (Step S130). When the interlacing process is performed, the CPU 40 drives the carriage motor 70, the motor 74, the print head 81, and the like on the basis of the dot pattern data and ejects the metallic ink S and the color ink from the print head 81 to perform printing of metallic color (Step S140). Then, the printing process is terminated. In addition, the process of Step S110 to S140 is executed as a process of the printing unit 42.

### C. Characteristics of LUT 62

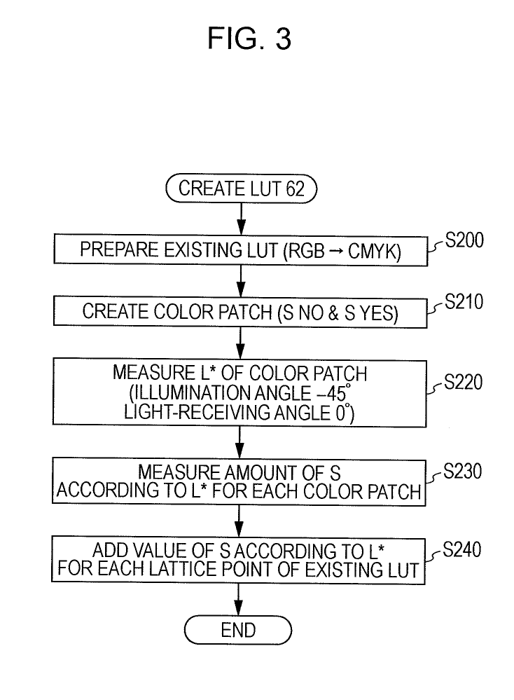

Characteristics of the LUT 62 are clarified by describing a method of creating the LUT 62 used for the above-mentioned printing process. A flowchart of the method of creating the LUT 62 is shown in FIG. 3. The creating of the LUT 62 is performed as shown in FIG. 3 as follows. First, an existing LUT describing a correspondence relationship between an input value in an RGB form and an input value of a CMYK form is prepared (step S200). That is, an LUT describing (without describing an output value of metallic ink S) only a correspondence relationship between an input value and an output value of color ink is prepared.

The LUT prepared in this case is for creating the LUT 62 used for performing printing by overlapping the color ink and the metallic ink S, and so it is an LUT create by reducing an ink duty limit value of color ink by the amount of the overlapped metallic ink S, as compared with an existing LUT created under a condition that does not include metallic ink S in an output value. The ink duty limit value of color ink is the upper limit of the sum of color ink that can be ejected onto a unit area of the printing medium. In the ink jet printer, when a large amount of ink is ejected onto a unit area of a printing medium, an ink blur occurs, and suitable color expression cannot be achieved. Therefore, such a limit is provided. In addition, the ink duty limit value is different according to printing conditions such as the printing medium and the kind of ink.

When the existing LUT is prepared, a color patch that does not use the metallic ink S and a color patch that uses the metallic ink S are created (Step S210). Here, the color patch is obtained by performing a color conversion process on image data having predetermined colors of which gradation changes at a predetermined pitch using the existing LUT and printing the image data using the printer 20. The color patch that does not use the metallic ink S is a color patch composed of only color regions and in this embodiment of the invention, is referred to as an only color patch. The color patch that uses the metallic ink S is a color patch that overlaps the metallic ink S on the only color patch at a predetermined duty and, in this embodiment of the invention, is referred to as an overlap color patch. In this embodiment, the overlap color patch is formed by overlapping the metallic ink S at an ink duty of 30%.

Here, the ink duty is set to 30% because the metallic feel expressed by the metallic ink S can be visually recognized best at the ink duty of 30% in the printing condition of this embodiment. However, the ink duty is not limited thereto. The ink duty of the metallic ink S may be set as a reference setting value to overlap the metallic ink S.

In addition, in this embodiment, as described above, the color patch is created by performing printing using the printer 20 that loads the LUT 62 for creation. This is because the performance of the LUT 62 created by the following method is enhanced by creating the color patch under the condition of using the LUT 62. Here, the color patch is not necessarily created by using the printer 20.

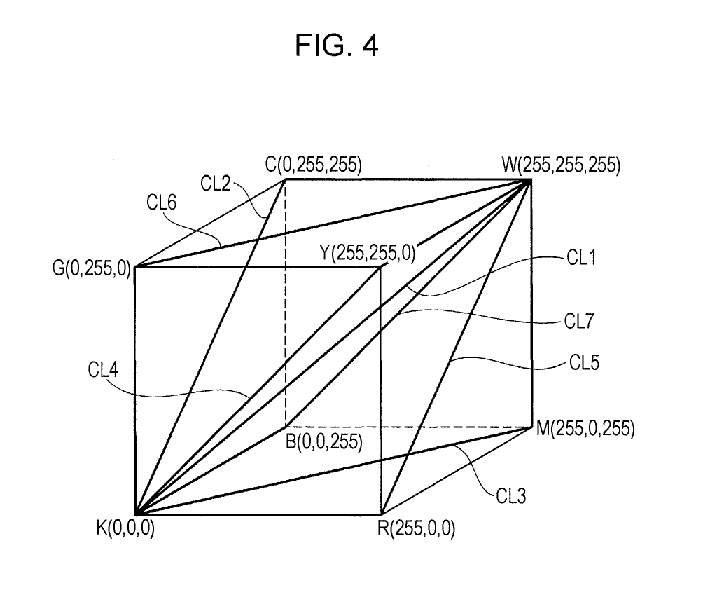

In this embodiment, the predetermined colors of the color patch are, as illustrated in FIG. 4, from among 8 points K(0, 0, 0), W(255, 255, 255), R(255, 0, 0), G(0, 255, 0), B(0, 0, 255), C(0, 255, 255), M(255, 0, 255), and Y(255, 255, 0) of the RGB color space (gradation values 0 to 255) related to an input value of the printer 20, colors of a color line CL1 linearly connecting the points K and W, a color line CL2 linearly connecting the points K, C, and W, a color line CL3 linearly connecting the points K, M, and W, a color line CL4 linearly connecting the points K, Y, and W, a color line CL5 linearly connecting the points K, R, and W, a color line CL6 linearly connecting the points K, G, and W, and a color line CL7 linearly connecting the points K, B, and W. In addition, the color gradation change pitch of the color patch is determined to divide each color line into 32 stages. In this embodiment, with regard to any color line, the color gradation value 1 is W(255, 255, 255), and the color gradation value 32 is K(0, 0, 0).

When the color patch is created, for the only color patch and the overlap color patch, brightness (L*) of each color gradation is measured using a colorimeter (Step S220). In this embodiment, L* was measured at an illumination angle of −45 degrees and a light-receiving angle of 0 degrees. This is because it was found that in this color measurement condition, a measurement result that is substantially similar to a color gradation change recognizable by the human eye is obtained. Here, the color measurement condition is not limited to this condition and may be suitably modified.

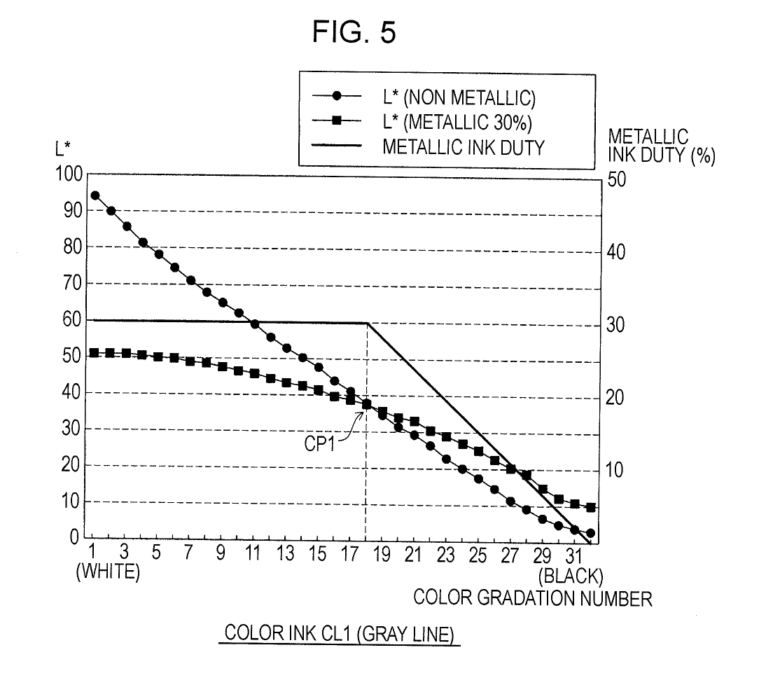

When L* is measured, the amount to be used (ink duty) of the metallic ink S for each color gradation is set according to the measured L* (Step S230). A method of setting the amount to be used of the metallic ink S will be described in detail with reference to FIG. 5. FIG. 5 shows a relationship between each color gradation for the only color patch (“non metallic” in the figure) and the overlap color patch (metallic 30% in the figure) in the color line CL1 and the L* measured in Step S220. In addition, an ink duty of the metallic ink S set on the basis of the relationship is shown. As illustrated in the figure, with regard to the color line CL1, it can be seen that a line of the only color patch and a line of the overlap color patch intersect at an intersection point CP1 (color gradation number 18).

In this embodiment, the ink duty of the metallic ink S is set to a constant value of 30% at a color gradation closer to white than the intersection point CP1, that is, a color gradation having a higher L* than the intersection point CP1. In addition, at a color gradation closer to black than the intersection point CP1, that is, at a color gradation having a lower L* than the intersection point CP1, the ink duty of the metallic ink S is set to be decreased with the decrease in L* and become 0% at black.

If a reduction starting point where the ink duty of the metallic ink S starts to be reduced is set to a color gradation having a higher L* than the intersection point CP1, at the reduction starting point, L* increases even though the color gradation becomes close to black (in this embodiment, this phenomenon is referred to as a brightness inversion phenomenon). In brief, in other color gradations, L* decreases as the color gradation becomes closer to black, so that a smooth gradation change in L* cannot be realized at the reduction starting point. From this point of view, it is preferable that the reduction starting point be set to a gradation having an L* equal to or lower than the L* of the intersection point CP1, and in this embodiment, the reduction starting point is set to the intersection point CP1.

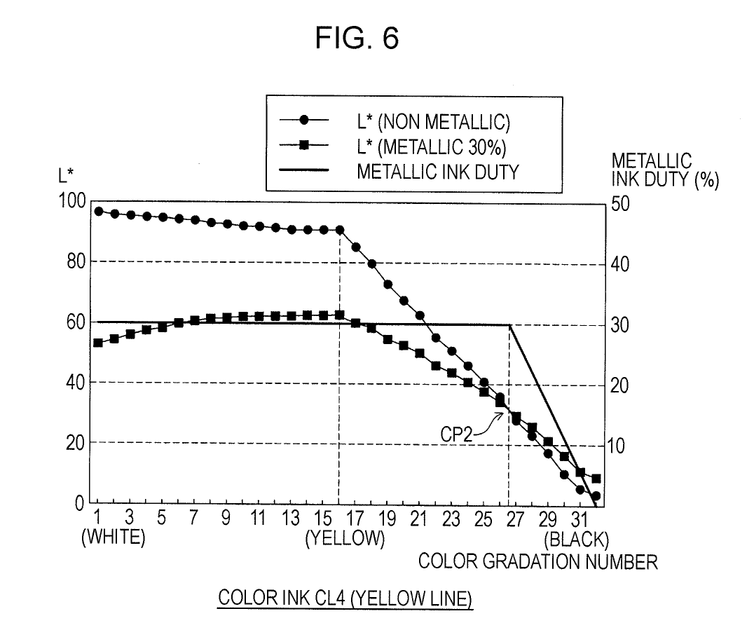

In the same manner, a relationship between each color gradation and L* in the color line CL4 is shown in FIG. 6. Similar to the color line CL1, with regard to the color line CL4, it can be seen that a line of the only color patch and a line of the overlap color patch intersect at an intersection point CP2. Therefore, with regard to the ink duty of the metallic ink S, similarly, for a color gradation having an higher L* than that of the intersection point CP2, the ink duty of the metallic ink S is set to a constant value of 30%, and for a color gradation having an L* equal to or lower than that of the intersection point CP2, the ink duty of the metallic ink S is set to be decreased with the decrease in L* and become 0% at black. In addition, although a description is omitted, the amount of the metallic ink S is set for other color lines in the same manner.

After the amount of the metallic ink S is set as described above, an output value of the metallic ink S is added at each lattice point of the existing LUT on the basis of the amount of the metallic ink S determined in Step S230 (Step S240). Specifically, first, since the color gradation number shown in the horizontal axes of FIGS. 5 and 6 corresponds to the number of color gradation changes of the color patch, the corresponding color gradation number is replaced by a gradation value of the existing LUT to obtain a relationship between the gradation value of the existing LUT and the metallic ink S. Then, an amount of the metallic ink S to be added to each lattice point that belongs to the color lines CL1 to CL7 is obtained on the basis of the obtained relationship. The amount of the metallic ink S of a lattice point that does not belong to the color lines CL1 to CL7 is calculated by an interpolation using the lattice points that belong to the color lines CL1 to CL7. The interpolation may use various well-known methods used for obtaining an output value between lattice points of an LUT. An amount of the metallic ink S is obtained for all lattice points in this manner and added, thereby completing the LUT 62. Otherwise, an amount of the metallic ink S may be set by converting an RGB value of each lattice point of an existing LUT into an L*a*b* value and obtaining a relationship between L* shown in FIG. 5 or 6 and an ink duty of the metallic ink S according to the value of L* of each lattice point.

In this embodiment, the configuration in which an amount of the metallic ink S for a lattice point that belongs to the color lines CL1 to CL7 is determined from the relationship between each color gradation and L* is employed. However, the number of set color lines and colors may be suitably set. For example, it is apparent that when the number of color lines is increased, an LUT having higher precision can be created.

The printer 20 having the above-mentioned configuration relatively reduces the use amount of the metallic ink S for a dark printing region where L* is equal to or less than a predetermined value. In other words, for a printing region where the ink duty of color inks is high and metallic feel obtained by the metallic ink S is relatively small, the use amount of the metallic ink S is reduced. Therefore, it is possible to effectively save the metallic ink S. In addition, in a configuration in which the metallic ink S uniformly overlaps regardless of the ink duty of the color ink, duty limitation becomes severe for the amount of the metallic ink S overlapped in a high-duty region of color ink, and a color reproduction range narrows. However, in the configuration of this embodiment, this problem is suppressed, so that the degradation of image quality can be suppressed.

In addition, the printer 20 having the above-mentioned configuration gradually decreases the amount of the metallic ink S with the decrease in L* in the printing region, so that a change in gradation of L* can be made smooth in the printing region with the reduced metallic ink S.

In addition, the printer 20 having the above-mentioned configuration reduces the amount of the metallic ink S in the printing region having an L* equal to or less than that of the intersection point between a line of the only color patch and a line of the overlap color patch, with regard to the color lines CL1 to CL7, so that the degradation in printing quality due to a brightness inversion phenomenon can be solved.

### D. Modified Examples

Modified Examples of the embodiment described above will be described.

### D-1. First Modified Example

In this example, the configuration in which the amount of the metallic ink S to be used is reduced in a case where a brightness (L*) of color expressed by color ink is equal to or less than a predetermined value is described. However, the index for reducing the amount of the metallic ink S to be used is not limited to brightness and various types of indices relating to color intensity expressed by color ink may be employed. For example, luminance, ink duty, and the like may be employed.

### D-2. Second Modified Example

In this example, a reduction point of the metallic ink S is determined by performing color measurement on the color patch. However, the color measurement may not be necessary and may be omitted. Here, of course, determining a reduction point of the metallic ink S by performing color measurement as in this embodiment is more preferable, since this can reliably suppress the brightness inversion phenomenon.

### D-3. Third Modified Example

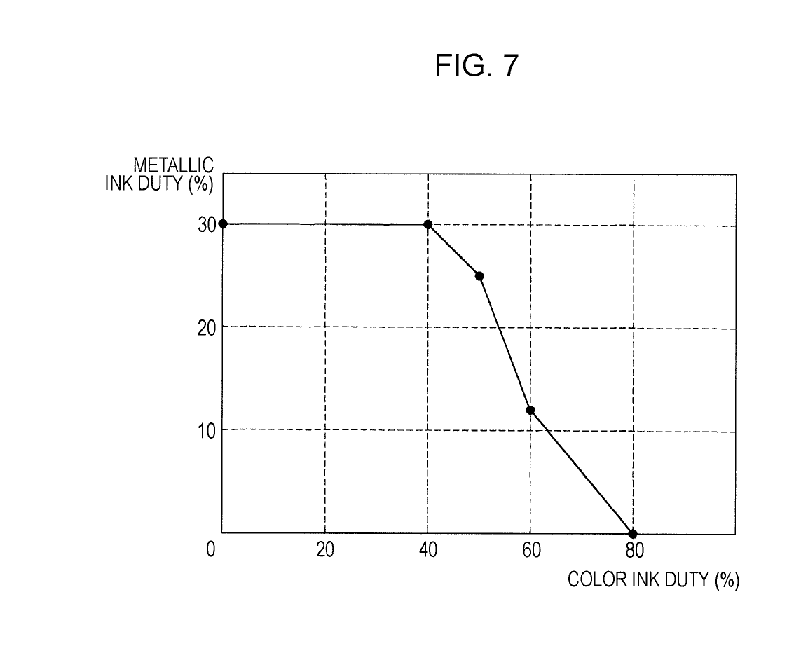

In this example, the printer 20 has the configuration in which the amount of the metallic ink S used for a printing process is determined by the LUT 62. However, the LUT 62 may not be necessarily used. For example, a table that describes the relationship between an ink duty of color ink and an ink duty of metallic ink S as illustrated in FIG. 7 may be stored in the EEPROM 60, and the CPU 40 may determine an amount of the metallic ink S on the basis of the ink duty of color ink with reference to the table. Otherwise, the amount of the metallic ink S may be determined according to various index values relating to color intensity expressed by an input value of color ink. The index values may employ, for example, an L* component of an L*a*b*color space, a Y component of an YCbCr color space, an L* color component of an L*u*v*color space, and a Y component of an XYZ color space. In this configuration, a load in creating an LUT can be reduced.

### D-4. Fourth Modified Example

In the embodiment described above, the configuration in which the ink duty of the metallic ink S is set to 30% in a printing region having an L* higher than that of the reduction point of the metallic ink S and the ink duty of the metallic ink S is set to be decreased with the decease in L* from the reduction point of the metallic ink S to become zero as black is described. However, a method of reducing the ink duty of the metallic ink S may be suitably set in consideration of a printing condition such as a printing medium, required printing quality, an amount of the metallic ink S to be saved, and the like. For example, an upper limit of the ink duty may be set to 25% or 35%, or the ink duty may be set to zero at a point having an L* higher than that of black. Otherwise, a configuration in which the ink duty may be set to, for example, 10% so as not to be zero at black may be employed. This example is not limited to the original configuration of reducing the amount of the metallic ink S to be used by the decrement in L*, and a configuration of reducing the amount by a predetermined amount in a printing region equal to or less than the reduction point may be employed. In this case, a certain degree of effect can be expected with a simple configuration.

### D-5. Fifth Modified Example

In this example, the ink duty of the metallic ink S in the case where L* is higher than a predetermined value is limited to a constant value (30%), a configuration in which a user can select a level for a metallic feel needed for a desired printing quality may be employed. In this case, for example, the printer 20 may have a configuration in which a plurality of kinds of LUT (for example, an LUT in which a maximum value of an ink duty is 30% and an LUT in which a maximum value thereof is 15%) are stored and an LUT selected and used by the user is changed. Otherwise, a configuration in which an amount of metallic ink S obtained by the LUT 62 is multiplied by a reduction ratio determined by the selection of a user to determine the amount of the metallic ink S may be employed.

### D-6. Sixth Modified Example

In the embodiment described above, the configuration in which printing of metallic color is performed using metallic ink and color ink is exemplified. However, the embodiment of the invention is not limited to the printing of metallic color, and may be applied to printing using color ink and various special gloss inks. The special gloss ink is ink for expressing a special gloss on a surface of a printed product subjected to printing and may include ink which has optical characteristics in which ink printed on a surface of a printed product is reflection angle-dependent and shows in various appearances at different angles, as well as metallic ink containing pigments for expressing metallic feel. Such ink may employ, specifically, in addition to the metallic ink, pearly gloss ink containing pigments for expressing pearly gloss feel after being fixed on a surface of a medium, lame ink or pear-skin ink containing pigment having minute convexes and concaves to express a so-called lame feel or pear-skin feel by generating diffused reflection after being fixed on a surface of a medium, or the like.

### D-7. Seventh Modified Example

In the embodiment described above, the printer 20 has a configuration for executing the entire printing process shown in FIG. 2. However, in a case where the printer 20 is connected to a computer, the computer may execute parts of the printing process. In this case, a printing system configured by the computer and the printer 20 may be recognized as a printing apparatus in a broad sense.

While the embodiments of the invention have been described above, the invention is not limited to the embodiments and can be modified in various manners without departing from the spirit and scope of the invention. For example, the invention may be applied to a variety of printing apparatuses such as an ink jet printer and a laser printer which performs printing by adhering special gloss toner and color toner on a printing medium. In addition, the invention can also be embodied as a method of creating an LUT, an LUT, a printing method, a printed product, programs, a recording medium, and the like, as well as a configuration of a printing apparatus.

The disclosure of Japanese Patent Application No. 2009-004893 filed Jan. 13, 2009 including specification, drawings and claims is incorporated herein by reference in its entirety.

What is claimed is:

1. A printing apparatus for performing printing using a special gloss material and a coloring material, comprising:
an input unit that inputs image data; and
a printing unit that controls an arrangement of the special gloss material and the coloring material on a printing medium on the basis of the input image data and prints the image data,
wherein the printing unit relatively reduces an amount of the special gloss material to be used in a shadow region that is a printing region where an index value relating to color intensity expressed by the coloring material is equal to or lower than a predetermined darkness value.

2. The printing apparatus according to claim 1, wherein the printing unit reduces an amount of the special gloss material to be used as the index value is darker in the shadow region.

3. The printing apparatus according to claim 1, wherein the predetermined value is a dark value, equal to or lower than the index value at an intersection between a line representing a relationship between a color gradation of a printing region and the index value in a case where printing is performed using only the coloring material and a line representing a relationship between a color gradation of a printing region and the index value in a case where printing is performed using the coloring material and the special gloss material.

4. The printing apparatus according to claim 1, wherein the index value is brightness.

5. The printing apparatus according to claim 4, wherein the brightness is a value measured at a light-receiving angle of 0 degrees and an illumination angle of −45 degrees.

6. A method of creating a lookup table which describes a correspondence relationship between an input value to a printing apparatus and output values of a special gloss material and a coloring material of the printing apparatus, the method comprising:
preparing an existing lookup table that describes a correspondence relationship between the input value and the output value of the coloring material; and
adding the output value of the special gloss material to the output value of the coloring material for each lattice point of the existing lookup table and creating a new lookup table,
wherein the output value of the special gloss material which is added is relatively reduced at a lattice point where an index value relating to color intensity expressed by the output value of the coloring material is equal to or lower than a predetermined darkness value.

7. The method according to claim 6, wherein the output value of the special gloss material which is added is reduced as the index value is darker at a lattice point where the index value is equal to or lower than a predetermined darkness value.

8. The method according to claim 6, further comprising:
a first color measurement process of performing color measurement on the index value for each predetermined color gradation in a printing region printed by using only the coloring material;
a second color measurement process of performing color measurement on the index value for each predetermined color gradation in a printing region printed by using the coloring material and the special gloss material; and
a process for obtaining an intersection index value that is the index value at an intersection between a line representing a relationship between the color gradation and the index value obtained in the first color measurement and a line representing a relationship between the color gradation and the index value obtained in the second color measurement,
wherein the predetermined value is a dark value, be equal to or lower than the intersection index value.

9. The method according to claim 6, wherein the index value is brightness.

10. The method according to claim 9, wherein the brightness is a value measured at a light-receiving angle of 0 degrees and an illumination angle of −45 degrees.

11. A lookup table that describes a correspondence relationship between an input value to a printing apparatus and output values of a special gloss material and a coloring material of the printing apparatus, wherein the output value of the special gloss material is relatively reduced at a lattice point where an index value relating to color intensity expressed by the output value of the coloring material is equal to or lower than a predetermined darkness value.

12. A printing method of performing printing using a special gloss material and a coloring material, the printing method comprising:
relatively reducing an amount of the special gloss material to be used in a printing region where an index value relating to color intensity expressed by the coloring material is equal to or lower than a predetermined darkness value.

13. A printed product printed using a special gloss material and a coloring material, wherein an amount of the special gloss material used is relatively small in a printing region where an index value relating to color intensity expressed by the coloring material is equal to or lower than a predetermined darkness value from among printing regions printed by overlapping the special gloss material and the coloring material with each other.
